(19) United States
(12) Patent Application Publication
(10) Pub. No.: US 2008/0229061 A1
(43) Pub. Date: Sep. 18, 2008

(54) Processor Element for use in a Network of Processor Elements

(75) Inventors: Christoph BRAUN, Muenchen (DE); Rupert GLASER, Woerth/Hoerlkofen (DE)

Correspondence Address: INFINEON TECHNOLOGIES AG;Patent Department, MUC 11.1.507, P.O. Box 221644, Munich, 80506, DE

(73) Assignee: INFINEON TECHNOLOGIES AG, Muenchen (DE)

(21) Appl. No.: 11/863,292

(22) Filed: Sep. 28, 2007

(30) Foreign Application Priority Data
Sep. 28, 2006 (DE) 10 2006 045 908.3

(51) Int. Cl. G06F 15/76; G06F 9/30

(52) U.S. Cl. 712/29; 712/E09.016

(57) ABSTRACT

In order to detect objects using a processor element for use in a network of processor elements which are connected to one another, the processor element comprises a processor, at least one interface for coupling to further processor elements of the network and an oscillator having a connection for coupling to an electrode outside the processor element.

### RELATED APPLICATION

This application claims priority to German Application No. 10 2006 045 908.3, filed 28 Aug. 2006, which is incorporated by reference herein in its entirety.

### FIELD OF THE INVENTION

The invention generally relates to a processor element for use in a network of a plurality of processor elements which are connected to one another, and to an area covering element having at least one processor element of this type.

### BACKGROUND

Networks comprising processor elements which are connected to one another may be used, for example, to detect measured data which are distributed over an area or a room or to output optical or acoustic signals, for example. In this case, the process of detecting measured data may comprise detecting items or people in the vicinity.

### SUMMARY

An object is to provide a processor element for use in a network of processor elements being able to detect items or people without high additional complexity.

### BRIEF DESCRIPTION OF THE DRAWINGS

Embodiments of the invention are explained in more detail below with reference to the accompanying drawings, in which

FIG. 1 shows an exemplary embodiment of an area covering element having a network of processor elements which are connected to one another, and

FIG. 2 shows the schematic design of a processor element for use in a network of processor elements which are connected to one another.

### DETAILED DESCRIPTION

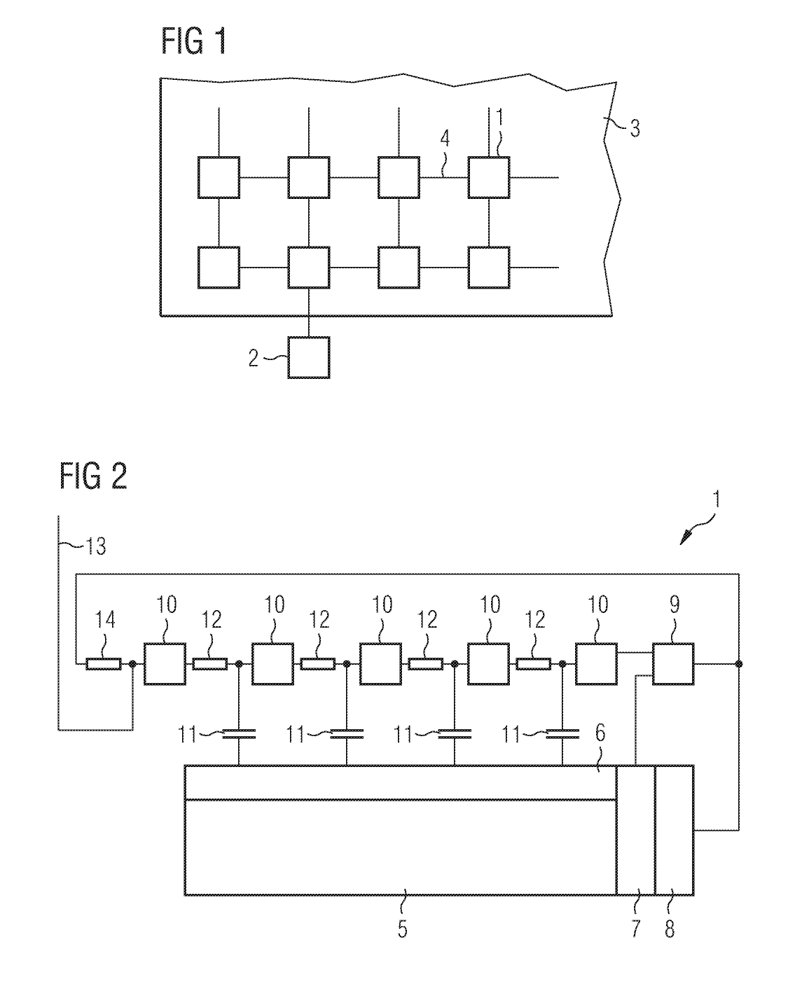

FIG. 1 shows an area covering element 3 which is used to cover any desired areas. The areas may be horizontal floors or vertical walls and may be curved or flat. The area covering element 3 may comprise a material which is conventional for covering the respective area, for example a carpet material or a plastic material for covering floors. The area covering element 3 is only partly illustrated and has a plurality of processor elements 1 which are arranged in a rectangular grid with respect to one another and are connected to one another. To this end, each processor element 1 has four interfaces which are used to connect it to the respective adjacent processor elements 1 by means of lines 4.

In this case, the processor elements 1 may be arranged in a regular grid, with the result that the distances between the adjacent processor elements 1 are essentially the same. In addition, it is also possible, however, to distribute the processor elements 1 in an irregular manner on the area covering element 3 in order to achieve a higher density of processor elements 1 at particular locations, for example. Likewise, the arrangement need not be effected in accordance with a rectangular grid but may also be effected in any other desired honeycomb structure, for example. The number of interfaces of each processor element 1 and the type of connection between the processor elements 1 are likewise variable. For example, each processor element 1 may also have only three interfaces which are used to connect it to adjacent processor elements 1. Furthermore, the processor elements 1 may also be connected to one another by means of buses, with the result that even one interface on its own suffices for particular processor elements 1 under certain circumstances.

An external processor element 2 which is connected to a processor element 1 inside the area covering element 3 is arranged outside the area covering element 3. In this case, the external processor element 2 may form an interface to a further area covering element 3 or may itself already be arranged in an adjacent area covering element 3 and may also again be part of the network which comprises processor elements 1 and is arranged in this adjacent area covering element 3.

The processor elements 1 are set up in such a manner that, once they have been connected to form a network, they have the ability to organize themselves or at least have the ability to be able to determine their spatial arrangement with respect to other processor elements. In this case, it may suffice for each processor element 1 to be able to identify adjacent processor elements, said processor element being able to identify, in particular, the directly adjacent processor elements 1. Each processor element 1 may thus also have a unique identification, so that the directly adjacent processor elements 1, in particular, can be determined using their identifications at least for some processor elements 1, with the result that spatial relationships between identified processor elements 1 can be determined.

Since, as a rule, the processor elements 1 are fastened to the area covering element 3 in accordance with a particular known pattern, the knowledge of the pattern for arranging the processor elements 1 and the information relating to processor elements 1 which are adjacent to one another can be used to determine which processor element 1 is situated where on the area covering element 3. If a plurality of area covering elements 3 are laid next to one another, they may either be connected to one another by means of defined interfaces, with the result that the processor elements 1 of each area covering element 3 form their own networks, or the processor elements 1 of adjacent area covering elements 3 may be connected to one another in such a manner that the processor elements 1 of a plurality of area covering elements 3 form a cohesive network with the ability to organize itself or at least to determine information relating to the spatial arrangement of the processor elements 1 with respect to one another.

FIG. 2 illustrates an embodiment of a processor element 1 for use in a network shown in FIG. 1. The processor element 1 has a microcontroller 5 which has a plurality of digital inputs and outputs. The processor element 1 also comprises a number of logic gates 9, 10 which together form a digital oscillator. The oscillator is connected to an electrode 13, with the result that the electrical properties of the latter influence the frequency of the oscillator. In this case, the electrode 13 is arranged in such a manner that its electrical properties and thus the frequency of the oscillator change under the influence of objects or people in the vicinity. In this manner, it is possible to determine, by evaluating the oscillator frequency, whether objects, for example items or people, are in the vicinity of the electrode 13 and thus the processor element 1 or whether said objects are approaching the electrode or moving away from the latter.

In the embodiment illustrated in FIG. 2, the oscillator is a ring oscillator having inverters 10 which are connected in series. The inverters 10 have, at the input, comparators which have a defined switching threshold even in the case of slowly changing input voltages. In this case, the inputs of the inverters 10 may also have Schmitt triggers in order to ensure clear switching. An uneven number of inverters 10 are connected to form a ring, at least the output of one inverter 10 being connected to the input of the following inverter 10 with the interposition of a resistor 12. That connection of a resistor 12 which is connected to an inverter input can be connected, by means of a capacitance 11, to a fixed reference potential inside the processor element 1. This may be a supply voltage connection inside the processor element 1 or else a digital output of the microcontroller 5. In the embodiment shown, there are five inverters 10, the outputs of four inverters 10 of which are connected to the following inverter 10 by means of such RC elements having a respective resistor 12 and a capacitance 11. All of the capacitances 11 of the RC elements are connected to a digital output of the microcontroller 5.

The digital outputs form a connecting block 6 of the microcontroller 5, the connections of the connecting block 6 being able to be changed to a high-impedance state independently of one another. To this end, the outputs of the connecting block 6 may be, for example, tristate outputs which can be switched to logic high or low or to a high-impedance state in which only a reduced current can still flow through the respective connected capacitance 11, with the result that the capacitance which electrically acts on the connection to the resistor 12 decreases. This makes it possible to influence the frequency of the oscillator. All of the RC elements slow down the signal propagation time through the series-connected inverters 10 and thus determine the frequency of the oscillator as long as the respective capacitances 11 are connected in a low-impedance manner and the RC elements are thus active. The time constants of the different RC elements may be set differently this case, with the result that as many different frequency values as possible can be set for the oscillator by activating different combinations of RC elements. In this case, at least one RC element may also be permanently connected to a reference potential in order to set a maximum frequency of the oscillator. The remaining RC elements may be connected to outputs of the connecting block 6, as illustrated, in order to change this maximum frequency.

An AND gate 9 having two inputs, one of which is connected to the output of an inverter 10 and the other of which is connected to an output 7 of the microcontroller 5, is also situated in the signal path of the oscillator. This makes it possible for the microcontroller 5 to switch the oscillator on and off. The output of the AND gate 9 is connected to an input 8 of the microcontroller 5, by means of which the latter can determine the frequency of the oscillator. However, the frequency of the oscillator may also be tapped off at any other suitable point.

Furthermore, an electrode 13 is coupled to the oscillator in such a manner that changes in the capacitance of the electrode 13 have an effect on the frequency of the oscillator. To this end, as illustrated in FIG. 2, the electrode 13 may be connected to an input of an inverter 10 which is not connected to an RC element and is connected to the upstream gate of the ring oscillator by means of a resistor 14. In the present case, the resistor 14 is connected to the output of the AND gate 9. The resistance 14 must be sufficiently high to make it possible for the capacitance of the electrode 13 to influence the oscillator frequency in the desired manner.

In other exemplary embodiments, the oscillator may also be of any other desired design. The oscillator may thus also be another digital oscillator or else an oscillator in an analogue circuit and may have a connection for connection to the electrode 13, the frequency of the oscillator being able to be changed using an electrode 13 which is connected to this connection. LC oscillators or crystal oscillators are also generally eligible as oscillator types. One possible way of switching the oscillator on and off may be provided by switching operation of the oscillator on and off or by using a gate to switch the forwarding of an output signal of the oscillator on and off.

For the purpose of determining the oscillator frequency, the output 7 is switched to high in order to start the oscillator. The oscillator is switched on for a particular period of time which is twenty milliseconds in the exemplary embodiment shown. During this time, the pulses of the oscillator oscillation which are applied to the input 8 are counted in order to determine a measure of the oscillator frequency.

In this case, the microcontroller 5 is set up in such a manner that it repeatedly carries out the measurement but in the process randomly changes the interval of time between two successive measurements so that it is possible to reduce the risk of mutual interference by a plurality of processor elements 1. Furthermore, the microcontroller 5 is set up in such a manner that the measurement results are checked for plausibility in order to reduce the risk of defective measurements. For example, provision may be made for a change in the oscillator frequency to have to last for a particular period of time in order to be deemed to be a reaction to an object in the vicinity of the electrode 13. It is likewise possible to check, as a prerequisite for a valid measurement, whether changes in the oscillator frequency do not take place abruptly, which could be a sign of the interference caused by the oscillation of an oscillator of another processor element 1. To this end, the rate of change of the oscillator frequency of successive measurements can be taken into account and a valid detection can be forwarded only when the rate of change undershoots a particular value.

All plausibility checks may also be made dependent on the objects to be detected and their behaviour. If, for example, the presence of people in the vicinity of the processor elements 1 is intended to be detected, a particular maximum speed at which the people move over the network comprising the processor elements 1 can be taken as a basis and used to set the sequence of measurements. For example, it is possible to calculate the amount of time for which a person is at least in the area of influence of an electrode 13 at this maximum speed and that patterns for operating the oscillator are set in such a manner that at least a particular number of measurements are carried out in this period of time in order to be able to reliably detect people and simultaneously reduce or preclude the risk of defective detection as a result of interfering effects.

1. Processor element for use in a network of processor elements which are connected to one another, the processor element having a processor, at least one interface for coupling to further processor elements of the network and an oscillator having a connection for coupling to an electrode outside the processor element.

2. Processor element according to claim 1, the processor being able to digitally set a fundamental frequency of the oscillator.

3. Processor element according to claim 1, the processor element being able to switch the oscillator on and off.

4. Processor element according to claim 3, the processor element being set up in such a manner that it can temporarily switch on the oscillator at random.

5. Processor element according to claim 3, the processor element being set up in such a manner that it can send information relating to the operation of the oscillator to further processor elements, can receive, from other processor elements, information relating to the operation of their oscillators, and can switch on its own oscillator in periods of time in which the oscillators of other processor elements are switched off.

6. Processor element according to claim 1, the processor element repeatedly measuring the frequency of the oscillator and generating a signal in the event of deviations from a fundamental frequency of the oscillator which extend over a plurality of frequency measurements.

7. Processor element according to claim 1, the processor element being set up to determine an item of location information relating to the arrangement of the processor element with respect to other processor elements.

8. Area covering element having at least one processor element according to claim 1.

9. Network having a plurality of processor elements, which according claim 1, which are connected to one another.
